(19) United States
(12) Patent Application Publication
(10) Pub. No.: US 2009/0280358 A1
(43) Pub. Date: Nov. 12, 2009

(54) PATTERNED MEDIUM AND METHOD OF PRODUCING PATTERNED MEDIUM

(75) Inventor: Hiroaki Kushima, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/371,860

(22) Filed: Feb. 16, 2009

(30) Foreign Application Priority Data
May 7, 2008 (JP) 2008-121029

(51) Int. Cl. G11B 5/62; B32B 37/00

(52) U.S. Cl. 428/848; 156/60; 156/289

(57) ABSTRACT

A patterned medium is produced by forming a cover layer on a provisional substrate which has a flat surface, forming a patterned recording layer on the cover layer, forming a reinforcing layer on the recording layer in order to form a recording part which is formed by the cover layer, the recording layer and the reinforcing layer, bonding one surface of a main substrate on the reinforcing layer of the recording part, and removing the provisional substrate after bonding the main substrate on the reinforcing layer.

### CROSS-REFERENCE TO RELATED APPLICATIONS

This application is based upon and claims the benefit of priority of the prior Japanese Patent Application No. 2008-121029, filed on May 7, 2008, the entire contents of which are incorporated herein by reference.

### FIELD

The present invention generally relates to patterned media and methods of producing patterned media, and more particularly to a patterned medium which is suited for realizing a high recording density and to a method of producing such a patterned medium.

### BACKGROUND

Recently, storage capacities of magnetic disk drives have increased, and various methods have been proposed to further improve the recording density in the horizontal recording and perpendicular recording. Patterned media, such as discrete track media and bit patterned media, have been developed as next-generation techniques for further increasing the recording densities of the recording media. In the patterned medium, a non-recording region is provided between recording regions on the medium, in order to reduce spreading when writing information on the medium. When the information is read from the medium, it is possible to prevent the Signal-to-Noise Ratio (SNR) of the read waveform from deteriorating due to magnetic interference which would otherwise be caused by the spreading at the time of writing the information. The non-recording region is provided between data tracks in the case of the discrete track medium, and the non-recording region is provided between recording bits in the case of the bit patterned medium.

For example, as a method of providing the recording regions and the non-recording regions on the recording medium, a Japanese Laid-Open Patent Publication No. 2005-122853 proposes a nano-imprint method which deposits a process layer, which includes a magnetic layer, and a mask layer on a medium substrate, forms grooves in the mask layer by pushing an original disk having concentrically formed projecting rings against the mask layer, and thereafter performs an etching to transfer patterns onto the process layer. On the other hand, a Japanese Laid-Open Patent Publication No. 11-185291 proposes a method which forms the patterned medium by forming a magnetic layer on a sheet-shaped substrate which has concavo-convex patterns, and bonding the sheet-shaped substrate to a main substrate, in order to improve the productivity of the patterned medium.

The patterned media formed by the proposed methods described above have concavo-convex patterned. The writing of information on and the reading of information from the patterned medium is performed by a magnetic head that is provided on a slider. This slider floats from the medium surface by a predetermined amount. For this reason, when the concavo-convex patterns are provided on the medium surface, the floating amount of the slider becomes unstable, to thereby make it difficult to stably write the information on and stably read the information from the pattered medium by the magnetic head. Hence, a Japanese Laid-Open Patent Publication No. 2007-257801 proposes a method of filling the concave portions on the medium surface by a non-magnetic material and thereafter etching back the non-magnetic material, in order to make the medium surface flat. Other methods of making the medium surface flat have been proposed in a Japanese Laid-Open Patent Publication No. 5-205257 and a U.S. Pat. No. 7,166,261, for example.

However, when filing the concave portions on the medium surface of the patterned medium by the non-magnetic material, the non-magnetic material is also deposited on the convex portions on the medium surface, and concavo-convex patterns still remain on the medium surface. For this reason, when the medium surface is etched back in this state, the concavo-convex patterns will remain on the medium surface. In addition, because of the differences in the composition components of the non-magnetic material filling the concave portions and a magnetic material forming the convex portions, the etching rates of the non-magnetic material and the magnetic material are different. Due to this difference in the etching rates, it is extremely difficult to uniformly planarize the medium surface by the etch-back. A polishing method may be employed as another example of the planarizing method, but the polishing method cannot eliminate the difference in the polishing rates caused by the different composition components of the non-magnetic material and the magnetic material. For this reason, it is difficult to process the medium surface on the order of several nm, and the increase in the number of processes and the processing time required to planarize the medium surface and the increase in the production cost are unavoidable.

Therefore, conventionally, there was a problem in that it is difficult to planarize the surface of the patterned medium in a simple and inexpensive manner.

### SUMMARY

One aspect of the present invention is to provide a patterned medium and a method of producing patterned medium, which enable planarization of the surface of the patterned medium in a simple and inexpensive manner.

According to one aspect of the present invention, a method of producing a patterned medium includes: forming a cover layer on a provisional substrate which has a flat surface; forming a patterned recording layer on the cover layer; forming a reinforcing layer on the recording layer in order to form a recording part which is formed by the cover layer, the recording layer and the reinforcing layer; bonding one surface of a main substrate on the reinforcing layer of the recording part; and removing the provisional substrate after bonding the main substrate on the reinforcing layer.

According to another aspect of the present invention, a patterned medium includes: a cover layer; a patterned recording layer formed on the cover layer; a reinforcing layer formed on the recording layer and forming a recording part together with the cover part and the recording layer; and a main substrate, wherein one surface of the main substrate is bonded to the reinforcing layer of the recording part via a bonding layer, and an exposed surface of the cover layer is flat.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1A through 1E are cross sectional views for explaining a method of producing a patterned medium in a first embodiment of the present invention;

FIGS. 2A through 2D are cross sectional views for explaining the method of producing the patterned medium in the first embodiment of the present invention;

FIGS. 3A through 3D are cross sectional views for explaining the method of producing the patterned medium in the first embodiment of the present invention;

FIGS. 4A through 4C are cross sectional views for explaining the method of producing the patterned medium in the first embodiment of the present invention;

FIG. 5 is a cross sectional view for explaining the method of producing the patterned medium in the first embodiment of the present invention;

FIGS. 6A through 6D are cross sectional views for explaining a method of producing a patterned medium in a second embodiment of the present invention;

FIGS. 7A through 7D are cross sectional views for explaining the method of producing the patterned medium in the second embodiment of the present invention;

FIGS. 8A through 8E are cross sectional views for explaining the method of producing the patterned medium in the second embodiment of the present invention;

FIGS. 9A through 9C are cross sectional views for explaining the method of producing the patterned medium in the second embodiment of the present invention;

FIG. 10 is a cross sectional view for explaining the method of producing the patterned medium in the second embodiment of the present invention;

FIGS. 11A through 11D are cross sectional views for explaining a method of producing a patterned medium in a third embodiment of the present invention;

FIGS. 12A through 12C are cross sectional views for explaining the method of producing the patterned medium in the third embodiment of the present invention;

FIGS. 13A through 13D are cross sectional views for explaining the method of producing the patterned medium in the third embodiment of the present invention;

FIGS. 14A through 14D are cross sectional views for explaining the method of producing the patterned medium in the third embodiment of the present invention;

FIGS. 15A through 15C are cross sectional views for explaining the method of producing the patterned medium in the third embodiment of the present invention; and

FIG. 16 is a cross sectional view for explaining the method of producing the patterned medium in the third embodiment of the present invention.

### DESCRIPTION OF EMBODIMENTS

Preferred embodiments of the present invention will be described with reference to the accompanying drawings.

According to one aspect of the present invention, a patterned medium is produced by forming a cover layer on a provisional substrate having a flat surface, forming a recording layer having concavo-convex patterns on the cover layer, forming a reinforcing layer on the recording layer, bonding a main substrate on the reinforcing layer, and removing the provisional substrate after bonding the main substrate on the reinforcing layer.

In this case, the patterned medium can be produced while maintaining the flatness of the medium surface, and it is possible to stably maintain the floating amount of the slider from the medium surface. In addition, it is possible to prevent an increase in the number of processes required to planarize the medium surface and to prevent an increase in the production cost.

Therefore, according to one aspect of the present invention, it is possible to provide a patterned medium and a method of producing patterned medium, which enable planarization of the surface of the patterned medium in a simple and inexpensive manner.

A description will now be given of the patterned medium and the method of producing patterned medium in each embodiment according to the present invention.

### First Embodiment

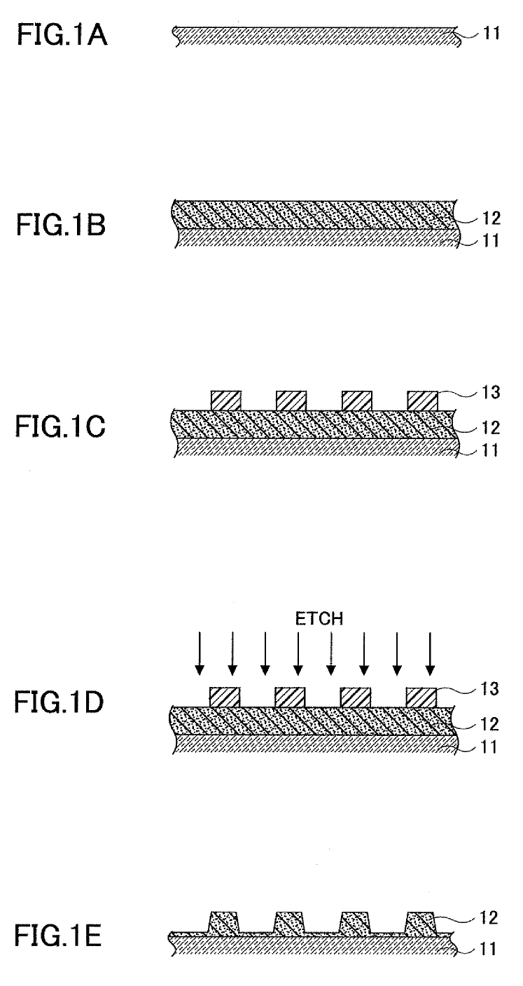

FIGS. 1A through 5 are cross sectional views for explaining the method of producing the patterned medium in a first embodiment of the present invention.

A provisional substrate 11 illustrated in FIG. 1A has a sufficiently flat surface, and a cover layer 12 illustrated in FIG. 1B is formed on the flat surface of the provisional substrate 11. The provisional substrate 11 is made of a suitable material which enables the cover layer 12 to be easily formed on the provisional substrate 11. Because the cover layer 12 forms a surface portion of the medium when the medium is finally formed, the cover layer 12 may be made of Diamond-Like Carbon (DLC) which is generally used as a surface protection layer of magnetic disks that are provided in magnetic disk drives. By using the DLC for the cover layer 12, it is possible to omit a process of forming a protection layer after the provisional substrate 11 is removed. In addition, a layer (not illustrated) made of a mold releasing agent, wax or the like may be formed in advance between the provisional substrate 11 and the cover layer 12 in order to facilitate the separation of the cover layer 12 and the provisional substrate 11. The cover layer 12 and layers formed thereafter, such as a recording layer 100, may be formed by a known method, such as spin-coating, sputtering and vacuum deposition.

Next, a resist layer 13 is formed on the cover layer 12, and the resist layer 13 is patterned as illustrated in FIG. 1C. The patterning of the resist layer 13 may be performed by a known method, such as photolithography and nano-imprint. Then, an etching is performed as illustrated in FIG. 1D using the patterned resist layer 13 as a mask. As a result, concavo-convex patterns are formed in the cover layer 12 as illustrated in FIG. 1E, and the resist layer 13 is thereafter removed.

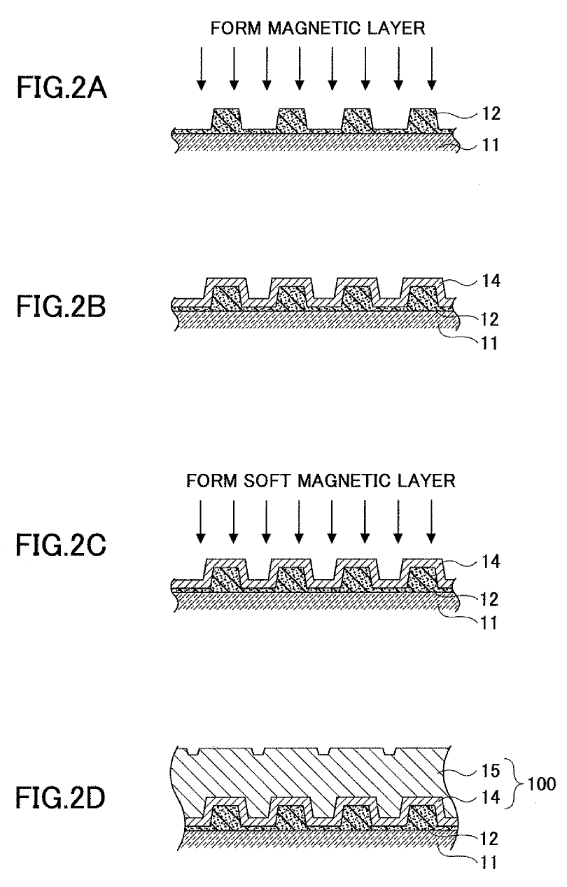

Next, the recording layer 100 for obtaining a desired magnetic recording characteristic is formed on the patterned cover layer 12, and a patterned recording layer 100 is formed. In this embodiment, the recording layer 100 includes a magnetic layer 14 and a soft magnetic layer 15, however, the layer structure of the recording layer 100 is not limited to such a layer structure. The magnetic layer 14 is formed on the patterned cover layer 12 by a known method, as illustrated in FIGS. 2A and 2B. The soft magnetic layer 15 is formed on the magnetic layer 14 by a known method, as illustrated in FIGS. 2C and 2D.

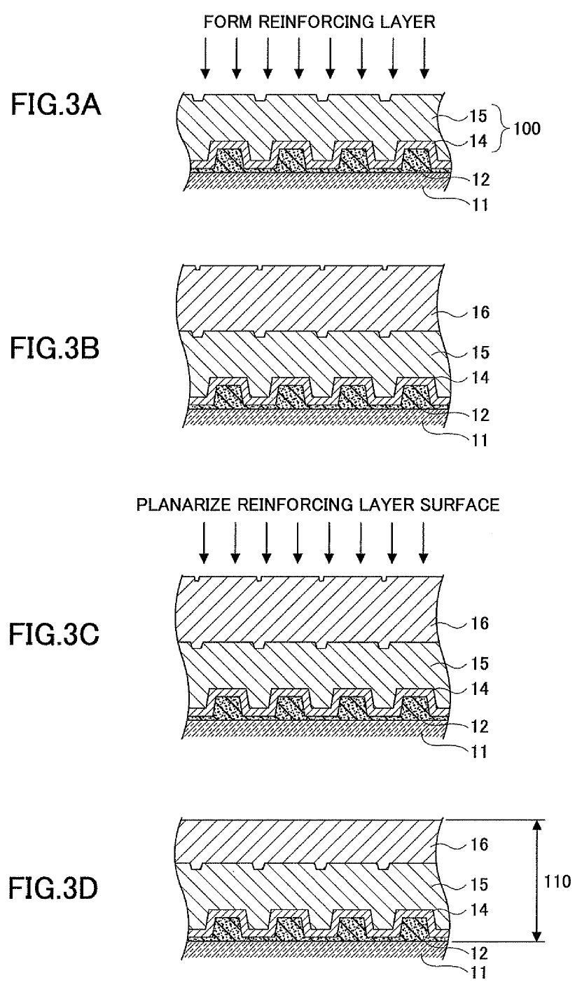

Thereafter, a reinforcing layer 16 is formed on the recording layer 100 (soft magnetic layer 15 in this example) by a known method, as illustrated in FIGS. 3A and 3B, in order to form a recording part 110. In this embodiment, in order to remove the undulations remaining on the surface of the reinforcing layer 16 of the recording part 110, an etching or a polishing is performed as illustrated in FIG. 3C in order to planarize the surface of the reinforcing layer 16 as illustrated in FIG. 3D. For this reason, the reinforcing layer 16 is preferably made of a material which facilitates the etching or polishing. In a case where a sufficient planarization process on the recording layer 100 can be achieved, it is possible to omit the reinforcing layer 16 and instead directly process, that is, planarize, the surface of recording layer 100 (soft magnetic layer 15 in this example).

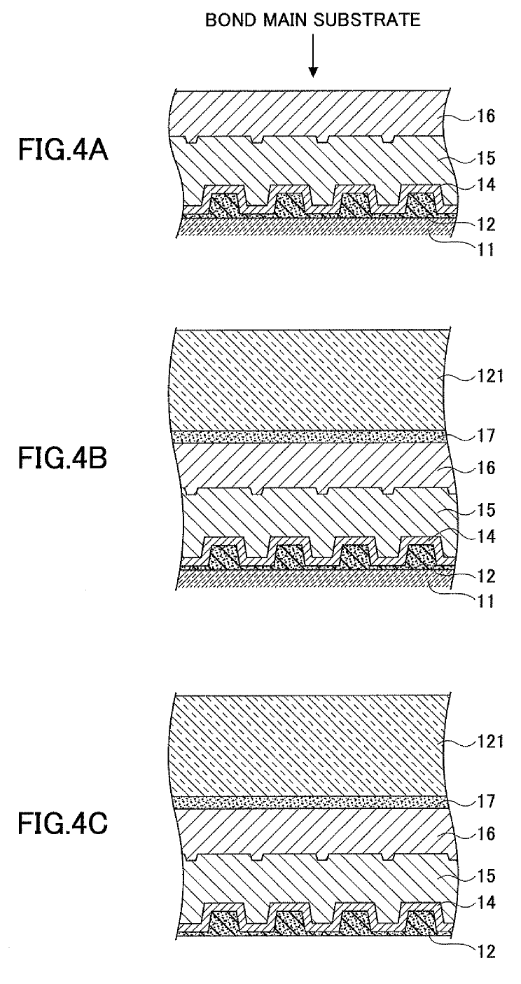

Next, the recording layer side of the recording part 110 is bonded on one surface or on both surfaces of the main substrate 121. In a case where the recording part 110 is bonded on one surface of the main substrate 121, a bonding layer 17 illustrated in FIG. 4B, for example, is formed on the reinforcing layer 16 illustrated in FIG. 4A, and the main substrate 121 is bonded on the reinforcing layer 16 via the bonding layer 17. Thereafter, the provisional substrate 11 is removed as illustrated in FIG. 4C.

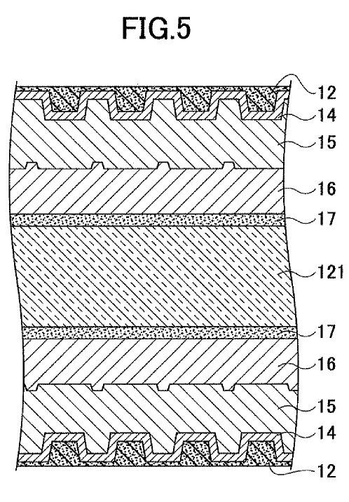

In a case where the recording part 110 is bonded on both surfaces of the main substrate 121, in a state where the recording part 110 is bonded on one surface of the main substrate 121 as illustrated in FIG. 4B, the reinforcing layer 16 of another recording part 110 is bonded on the other surface of the main substrate 121 via another bonding layer 17. Thereafter, the provisional substrate 11 of each of the recording parts 110 is removed as illustrated in FIG. 5.

The main substrate 121 is desirably formed by a glass or aluminum substrate that is generally used in magnetic disks. The main substrate 121 and the recording part 110 are connected by bonding, and the main substrate 121 or the recording layer side of the recording part 110 may be subjected to a surface processing depending on the bonding method that is employed. In addition, if the bonding surface may include undulations to a certain extent by the use of an adhesive or the like, it is possible to omit the planarization process to planarize the surface undulations on the reinforcing layer 16 or the recording layer 100.

The surface of the cover layer 12 after the provisional substrate 11 is removed is flat. In other words, a predetermined flatness is maintained at the surface of the cover layer 12 because no patterning process is performed directly on the surface of the cover layer 12. Of course, an etching, a polishing or the like may be performed in order to further planarize the surface of the cover layer 12. In addition, a protection layer (not illustrated) may be formed on the surface of the cover layer 12, and a lubricant (not illustrated) for improving the sliding between the slider and the medium surface may be coated on the surface of the cover layer 12 or the protection layer.

The patterned medium having the flat medium surface is produced by performing the processes described above.

Next, a description will be given of a case where the mold releasing agent, wax or the like is formed in advance between the provisional substrate 11 and the cover layer 12, in order to facilitate the removal of the provisional substrate 11 from the cover layer 12.

For example, a fluoric mold releasing agent or a silicon mold releasing agent is coated on the provisional substrate 11, and the recording part 110 is formed by forming the cover layer 12 and the recording layer 100 on the mold releasing agent. In this case, the recording layer side of the recording part 110 is bonded to the main substrate 121, and the provisional substrate 11 is removed from the recording part 110. Because the mold releasing agent is formed between the provisional substrate 11 and the cover layer 12 of the recording part 110, the provisional substrate 11 can be removed with ease. In addition, if the mold releasing agent remains on the surface of the cover layer 12, a cleaning may be performed to remove the residual mold releasing agent on the cover layer 12.

Hot wax may be used in place of the mold releasing agent. In this case, the hot wax is coated on the provisional substrate 11, and the recording part 110 is formed by forming the cover layer 12 and the recording layer 100 on the hot wax. In this case, the recording layer side of the recording part 110 is bonded to the main substrate 121, and the provisional substrate 11 is removed from the recording part 110. Because the hot wax is formed between the provisional substrate 11 and the cover layer 12 of the recording part 110, the provisional substrate 11 can be removed with ease by applying heat. In addition, if the hot wax remains on the surface of the cover layer 12, a cleaning may be performed to remove the residual hot wax on the cover layer 12.

When bonding the recording part 110 and the main substrate 121 using the bonding layer 17, an epoxy adhesive agent, a thermosetting resin, an ultraviolet curing resin or the like may be used for the bonding layer 17. For example, the recording part 110 and the main substrate 121 may be bonded by coating the adhesive or resin on the bonding surface of one of the recording part 110 and the main substrate 121 or, on both the bonding surface of the recording part 110 and the bonding surface of the main substrate 121. Thereafter, the adhesive or resin is cured by applying heat or by irradiating ultraviolet ray, depending on the type of adhesive or resin used. As a result, the recording part 110 and the main substrate 121 are bonded satisfactorily, and the desired patterned medium can be produced.

### Second Embodiment

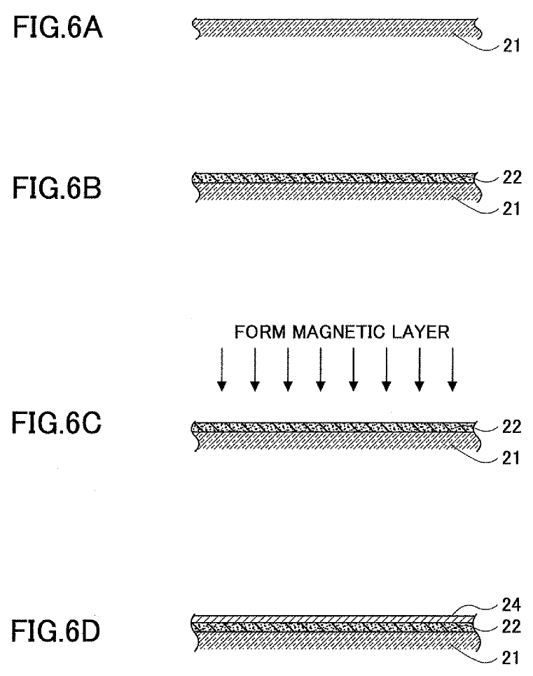

FIGS. 6A through 10 are cross sectional views for explaining the method of producing the patterned medium in a second embodiment of the present invention.

A provisional substrate 21 illustrated in FIG. 6A has a sufficiently flat surface, and a cover layer 22 illustrated in FIG. 6B is formed on the flat surface of the provisional substrate 21. The provisional substrate 21 is made of a suitable material which enables the cover layer 22 to be easily formed on the provisional substrate 21. Because the cover layer 22 forms a surface portion of the medium when the medium is finally formed, the cover layer 22 may be made of DLC which is generally used as a surface protection layer of magnetic disks that are provided in magnetic disk drives. By using the DLC for the cover layer 22, it is possible to omit a process of forming a protection layer after the provisional substrate 21 is removed. In addition, a layer (not illustrated) made of a mold releasing agent, wax or the like may be formed in advance between the provisional substrate 21 and the cover layer 22 in order to facilitate the separation of the cover layer 22 and the provisional substrate 21. The cover layer 22 and layers formed thereafter, such as a recording layer 200, may be formed by a known method, such as spin-coating, sputtering and vacuum deposition.

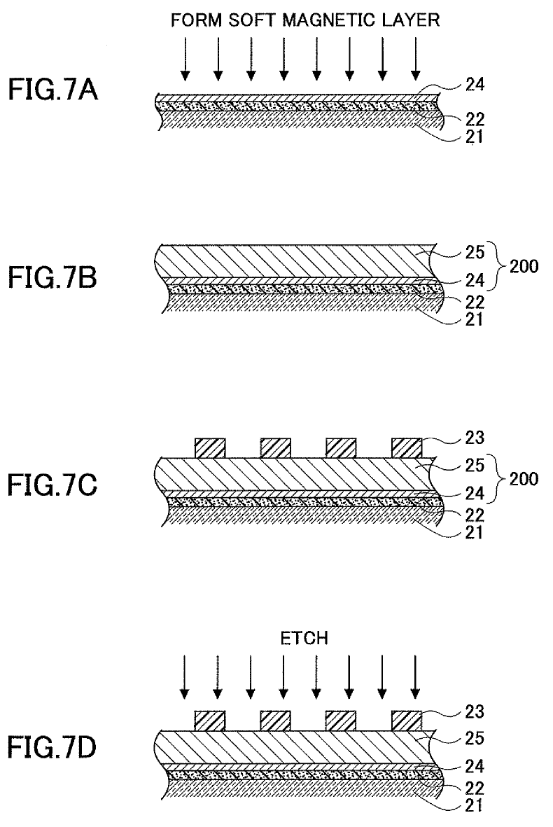

Next, the recording layer 200 for obtaining a desired magnetic recording characteristic is formed on the cover layer 22. In this embodiment, the recording layer 200 includes a magnetic layer 24 and a soft magnetic layer 25, however, the layer structure of the recording layer 200 is not limited to such a layer structure. The magnetic layer 24 is formed on the cover layer 22 by a known method, as illustrated in FIGS. 6C and 6D. The soft magnetic layer 25 is formed on the magnetic layer 24 by a known method, as illustrated in FIGS. 7A and 7B.

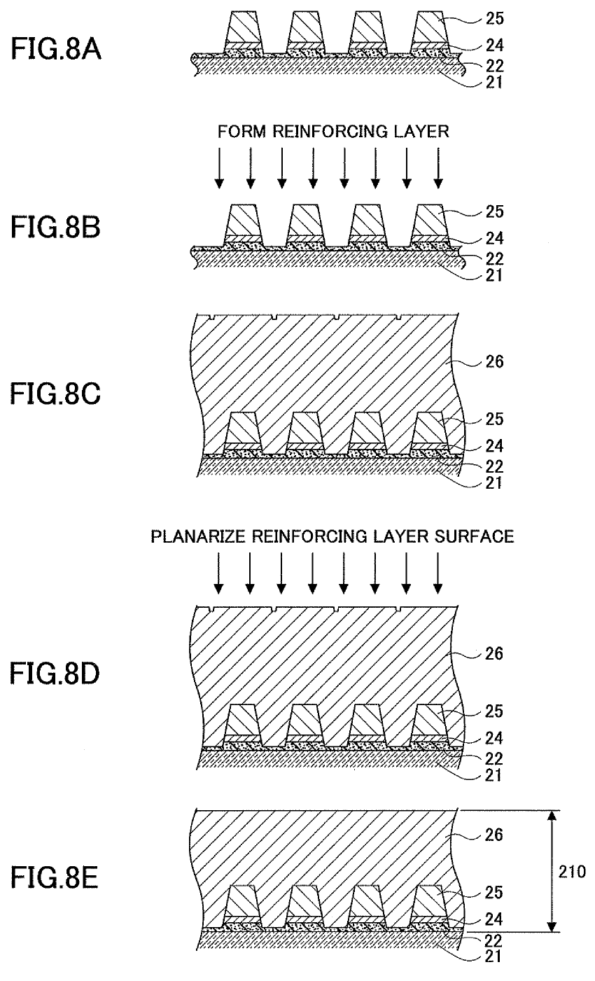

Next, a resist layer 23 is formed on the soft magnetic layer 25, and the resist layer 23 is patterned as illustrated in FIG. 7C. The patterning of the resist layer 23 may be performed by a known method, such as photolithography and nano-imprint. Then, an etching is performed as illustrated in FIG. 7D using the patterned resist layer 23 as a mask, in order to remove the soft magnetic layer 25, the magnetic layer 24 and at least a surface portion of the cover layer 22. As a result, concavo-convex patterns are formed in the recording layer 200 as illustrated in FIG. 8A, and the resist layer 23 is thereafter removed.

Thereafter, a reinforcing layer 26 is formed on the recording layer 200 by a known method, as illustrated in FIGS. 8B and 8C, in order to form a recording part 210. In this embodiment, in order to remove the undulations remaining on the surface of the reinforcing layer 26 of the recording part 210, an etching or a polishing is performed as illustrated in FIG. 8D in order to planarize the surface of the reinforcing layer 26 as illustrated in FIG. 8E. For this reason, the reinforcing layer 26 is preferably made of a material which facilitates the etching or polishing.

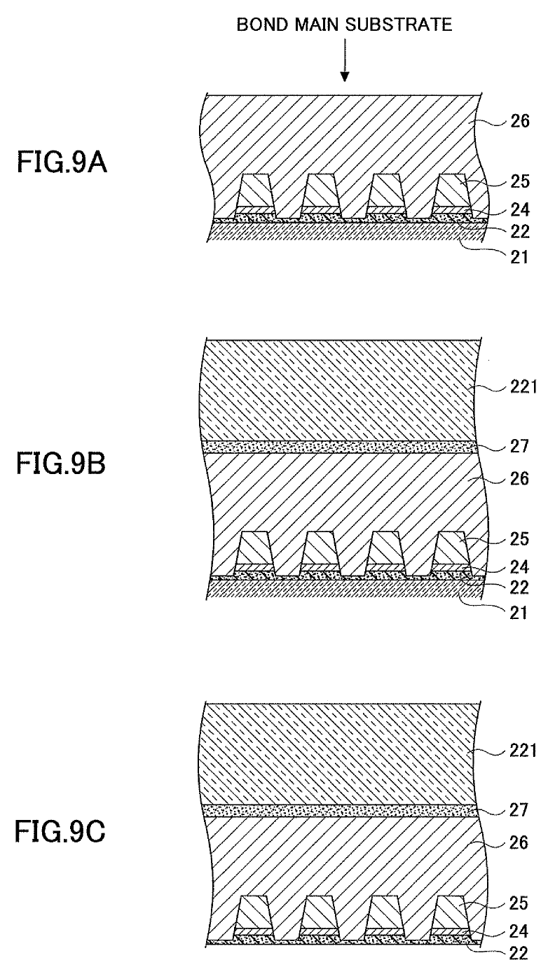

Next, the recording layer side of the recording part 210 is bonded on one surface or on both surfaces of a main substrate 221. In a case where the recording part 210 is bonded on one surface of the main substrate 221, a bonding layer 27 illustrated in FIG. 9A, for example, is formed on the reinforcing layer 26 illustrated in FIG. 9B, and the main substrate 221 is bonded on the reinforcing layer 26 via the bonding layer 27. Thereafter, the provisional substrate 21 is removed as illustrated in FIG. 9C.

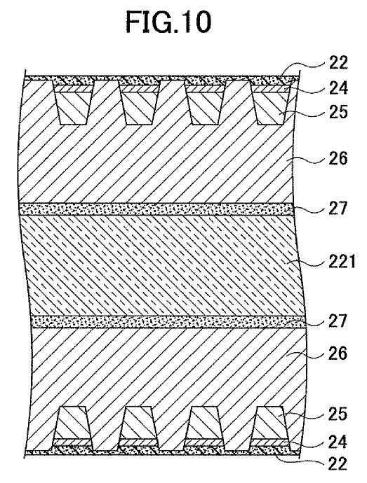

In a case where the recording part 210 is bonded on both surfaces of the main substrate 221, in a state where the recording part 210 is bonded on one surface of the main substrate 221 as illustrated in FIG. 9B, the reinforcing layer 26 of another recording part 210 is bonded on the other surface of the main substrate 221 via another bonding layer 27. Thereafter, the provisional substrate 21 of each of the recording parts 210 is removed as illustrated in FIG. 10.

The main substrate 221 is desirably formed by a glass or aluminum substrate that is generally used in magnetic disks. The main substrate 221 and the recording part 210 are connected by bonding, and the main substrate 221 or the recording layer side of the recording part 210 may be subjected to a surface processing depending on the bonding method that is employed. In addition, if the bonding surface may include undulations to a certain extent by the use of an adhesive or the like, it is possible to omit the planarization process to planarize the surface undulations on the reinforcing layer 26.

The surface of the cover layer 22 after the provisional substrate 21 is removed is flat. In other words, a predetermined flatness is maintained at the surface of the cover layer 22 because no patterning process is performed directly on the surface of the cover layer 22. Of course, an etching, a polishing or the like may be performed in order to further planarize the surface of the cover layer 22. In addition, a protection layer (not illustrated) may be formed on the surface of the cover layer 22, and a lubricant (not illustrated) for improving the sliding between the slider and the medium surface may be coated on the surface of the cover layer 22 or the protection layer.

The patterned medium having the flat medium surface is produced by performing the processes described above.

Next, a description will be given of a case where the mold releasing agent, wax or the like is formed in advance between the provisional substrate 21 and the cover layer 22, in order to facilitate the removal of the provisional substrate 21 from the cover layer 22.

For example, a fluoric mold releasing agent or a silicon mold releasing agent is coated on the provisional substrate 21, and the recording part 210 is formed by forming the cover layer 22 and the recording layer 200 on the mold releasing agent. In this case, the recording layer side of the recording part 210 is bonded to the main substrate 221, and the provisional substrate 21 is removed from the recording part 210. Because the mold releasing agent is formed between the provisional substrate 21 and the cover layer 22 of the recording part 210, the provisional substrate 21 can be removed with ease. In addition, if the mold releasing agent remains on the surface of the cover layer 22, a cleaning may be performed to remove the residual mold releasing agent on the cover layer 22.

Hot wax may be used in place of the mold releasing agent. In this case, the hot wax is coated on the provisional substrate 21, and the recording part 210 is formed by forming the cover layer 22 and the recording layer 200 on the hot wax. In this case, the recording layer side of the recording part 210 is bonded to the main substrate 221, and the provisional substrate 21 is removed from the recording part 210. Because the hot wax is formed between the provisional substrate 21 and the cover layer 22 of the recording part 210, the provisional substrate 21 can be removed with ease by applying heat. In addition, if the hot wax remains on the surface of the cover layer 22, a cleaning may be performed to remove the residual hot wax on the cover layer 22.

When bonding the recording part 210 and the main substrate 221 using the bonding layer 27, an epoxy adhesive agent, a thermosetting resin, an ultraviolet curing resin or the like may be used for the bonding layer 27. For example, the recording part 210 and the main substrate 221 may be bonded by coating the adhesive or resin on the bonding surface of one of the recording part 210 and the main substrate 221 or, on both the bonding surface of the recording part 210 and the bonding surface of the main substrate 221. Thereafter, the adhesive or resin is cured by applying heat or by irradiating ultraviolet ray, depending on the type of adhesive or resin used. As a result, the recording part 210 and the main substrate 221 are bonded satisfactorily, and the desired patterned medium can be produced.

### Third Embodiment

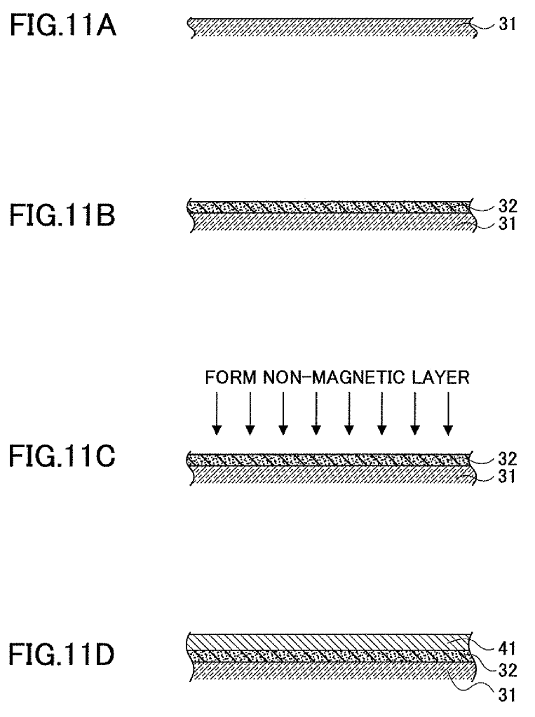

FIGS. 11A through 16 are cross sectional views for explaining the method of producing the patterned medium in a third embodiment of the present invention.

A provisional substrate 31 illustrated in FIG. 11A has a sufficiently flat surface, and a cover layer 32 illustrated in FIG. 11B is formed on the flat surface of the provisional substrate 31. The provisional substrate 31 is made of a suitable material which enables the cover layer 32 to be easily formed on the provisional substrate 31. Because the cover layer 32 forms a surface portion of the medium when the medium is finally formed, the cover layer 32 may be made of DLC which is generally used as a surface protection layer of magnetic disks that are provided in magnetic disk drives. By using the DLC for the cover layer 32, it is possible to omit a process of forming a protection layer after the provisional substrate 31 is removed. In addition, a layer (not illustrated) made of a mold releasing agent, wax or the like may be formed in advance between the provisional substrate 31 and the cover layer 32 in order to facilitate the separation of the cover layer 32 and the provisional substrate 31. The cover layer 32 and layers formed thereafter, such as a recording layer 300, may be formed by a known method, such as spin-coating, sputtering and vacuum deposition.

Next, a non-magnetic layer 41 is formed on the cover layer 32 as illustrated in FIGS. 11C and 11D.

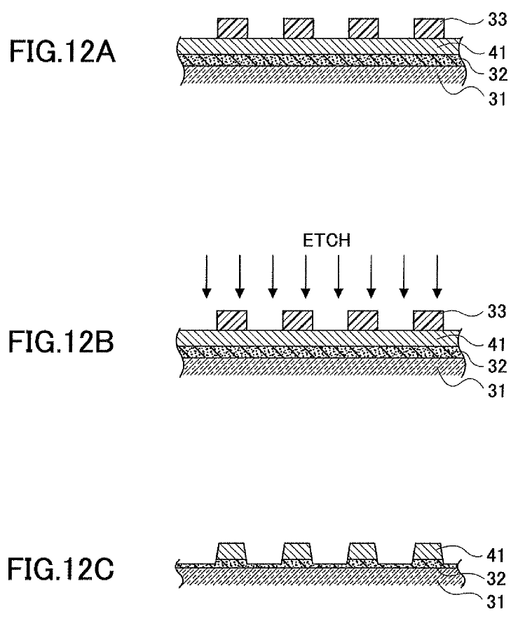

Next, a resist layer 33 is formed on the non-magnetic layer 41, and the resist layer 33 is patterned as illustrated in FIG. 12A. The patterning of the resist layer 33 may be performed by a known method, such as photolithography and nano-imprint. Then, an etching is performed as illustrated in FIG. 12B using the patterned resist layer 33 as a mask. As a result, the non-magnetic layer 41 and at least a surface portion of the cover layer 32 are removed. As a result, concavo-convex patterns are formed in the non-magnetic layer 41 as illustrated in FIG. 12C, and the resist layer 33 is thereafter removed.

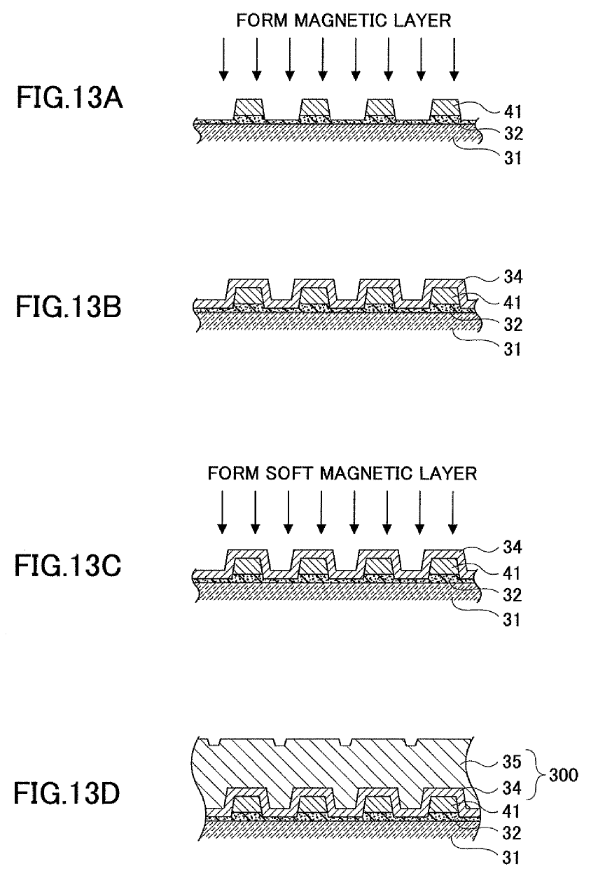

Next, the recording layer 300 for obtaining a desired magnetic recording characteristic is formed on the patterned non-magnetic layer 41. In this embodiment, the recording layer 300 includes a magnetic layer 34 and a soft magnetic layer 35, however, the layer structure of the recording layer 300 is not limited to such a layer structure. The magnetic layer 34 is formed on the patterned non-magnetic layer 41 by a known method, as illustrated in FIGS. 13A and 13B. The soft magnetic layer 35 is formed on the magnetic layer 34 by a known method, as illustrated in FIGS. 13C and 13D.

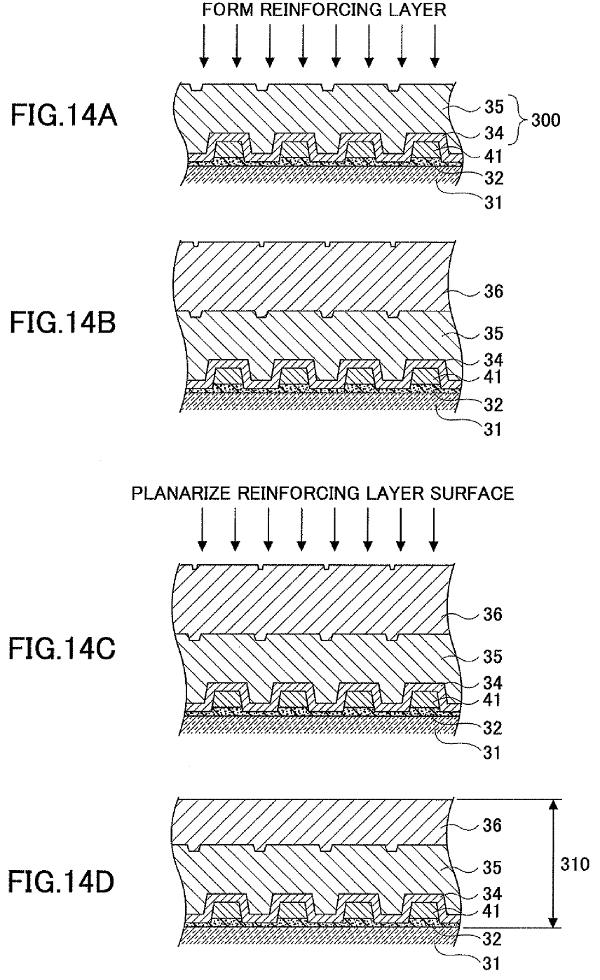

Thereafter, a reinforcing layer 36 is formed on the recording layer 300 (soft magnetic layer 35 in this example) by a known method, as illustrated in FIGS. 14A and 14B, in order to form a recording part 310. In this embodiment, in order to remove the undulations remaining on the surface of the reinforcing layer 36 of the recording part 310, an etching or a polishing is performed as illustrated in FIG. 14C in order to planarize the surface of the reinforcing layer 36 as illustrated in FIG. 14D. For this reason, the reinforcing layer 36 is preferably made of a material which facilitates the etching or polishing. In a case where a sufficient planarization process on the recording layer 300 can be achieved, it is possible to omit the reinforcing layer 36 and instead directly process, that is, planarize, the surface of recording layer 300 (soft magnetic layer 35 in this example).

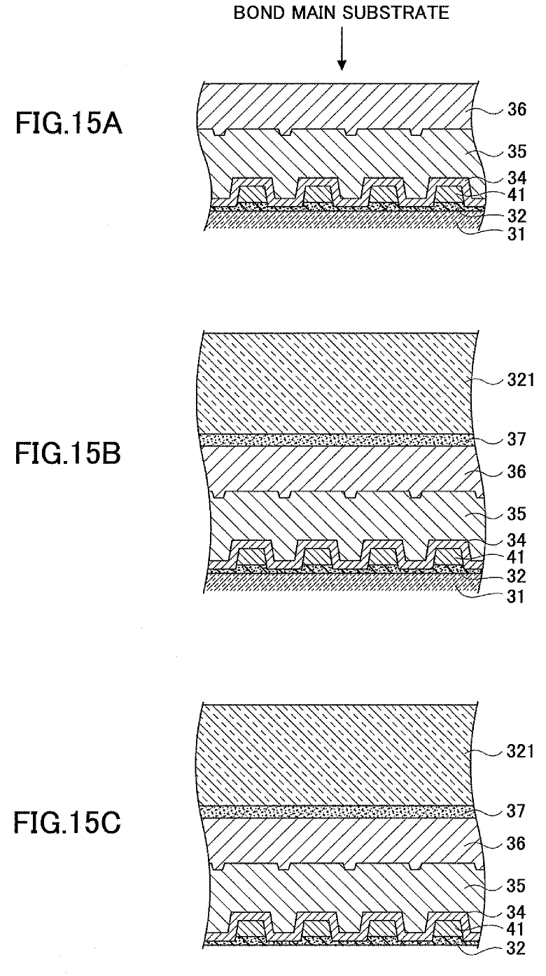

Next, the recording layer side of the recording part 310 is bonded on one surface or on both surfaces of the main substrate 321. In a case where the recording part 310 is bonded on one surface of the main substrate 321, a bonding layer 37 illustrated in FIG. 15B, for example, is formed on the reinforcing layer 36 illustrated in FIG. 15A, and the main substrate 321 is bonded on the reinforcing layer 36 via the bonding layer 37. Thereafter, the provisional substrate 31 is removed as illustrated in FIG. 15C.

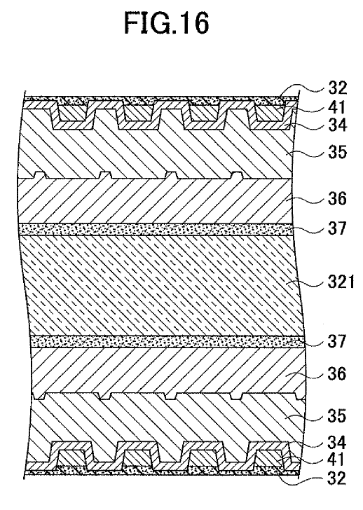

In a case where the recording part 310 is bonded on both surfaces of the main substrate 321, in a state where the recording part 310 is bonded on one surface of the main substrate 321 as illustrated in FIG. 15B, the reinforcing layer 36 of another recording part 310 is bonded on the other surface of the main substrate 321 via another bonding layer 37. Thereafter, the provisional substrate 31 of each of the recording parts 310 is removed as illustrated in FIG. 16.

The main substrate 321 is desirably formed by a glass or aluminum substrate that is generally used in magnetic disks. The main substrate 321 and the recording part 310 are connected by bonding, and the main substrate 321 or the recording layer side of the recording part 310 may be subjected to a surface processing depending on the bonding method that is employed. In addition, if the bonding surface may include undulations to a certain extent by the use of an adhesive or the like, it is possible to omit the planarization process to planarize the surface undulations on the reinforcing layer 36 or the recording layer 300.

The surface of the cover layer 32 after the provisional substrate 31 is removed is flat. In other words, a predetermined flatness is maintained at the surface of the cover layer 32 because no patterning process is performed directly on the surface of the cover layer 32. Of course, an etching, a polishing or the like may be performed in order to further planarize the surface of the cover layer 32. In addition, a protection layer (not illustrated) may be formed on the surface of the cover layer 32, and a lubricant (not illustrated) for improving the sliding between the slider and the medium surface may be coated on the surface of the cover layer 32 or the protection layer.

The patterned medium having the flat medium surface is produced by performing the processes described above.

Next, a description will be given of a case where the mold releasing agent, wax or the like is formed in advance between the provisional substrate 31 and the cover layer 32, in order to facilitate the removal of the provisional substrate 31 from the cover layer 32.

For example, a fluoric mold releasing agent or a silicon mold releasing agent is coated on the provisional substrate 31, and the recording part 310 is formed by forming the cover layer 32 and the recording layer 300 on the mold releasing agent. In this case, the recording layer side of the recording part 310 is bonded to the main substrate 321, and the provisional substrate 31 is removed from the recording part 310. Because the mold releasing agent is formed between the provisional substrate 31 and the cover layer 32 of the recording part 310, the provisional substrate 31 can be removed with ease. In addition, if the mold releasing agent remains on the surface of the cover layer 32, a cleaning may be performed to remove the residual mold releasing agent on the cover layer 32.

Hot wax may be used in place of the mold releasing agent. In this case, the hot wax is coated on the provisional substrate 31, and the recording part 310 is formed by forming the cover layer 32 and the recording layer 300 on the hot wax. In this case, the recording layer side of the recording part 310 is bonded to the main substrate 321, and the provisional substrate 31 is removed from the recording part 310. Because the hot wax is formed between the provisional substrate 31 and the cover layer 32 of the recording part 310, the provisional substrate 31 can be removed with ease by applying heat. In addition, if the hot wax remains on the surface of the cover layer 32, a cleaning may be performed to remove the residual hot wax on the cover layer 32.

When bonding the recording part 310 and the main substrate 321 using the bonding layer 37, an epoxy adhesive agent, a thermosetting resin, an ultraviolet curing resin or the like may be used for the bonding layer 37. For example, the recording part 310 and the main substrate 321 may be bonded by coating the adhesive or resin on the bonding surface of one of the recording part 310 and the main substrate 321 or, on both the bonding surface of the recording part 310 and the bonding surface of the main substrate 321. Thereafter, the adhesive or resin is cured by applying heat or by irradiating ultraviolet ray, depending on the type of adhesive or resin used. As a result, the recording part 310 and the main substrate 321 are bonded satisfactorily, and the desired patterned medium can be produced.

All examples and conditional language recited herein are intended for pedagogical purposes to aid the reader in understanding the invention and the concepts contribute by the inventor to furthering the art, and are to be construed as being without limitation to such specifically recited examples and conditions, nor does the organization of such examples in the specification related to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of producing a patterned medium, comprising:
forming a cover layer on a provisional substrate which has a flat surface;
forming a patterned recording layer on the cover layer;
forming a reinforcing layer on the recording layer in order to form a recording part which is formed by the cover layer, the recording layer and the reinforcing layer;
bonding one surface of a main substrate on the reinforcing layer of the recording part; and
removing the provisional substrate after bonding the main substrate on the reinforcing layer.

2. The method of producing the patterned medium as claimed in claim 1, further comprising:
patterning the cover layer,
wherein the recording layer is formed on the patterned cover layer.

3. The method of producing the patterned medium as claimed in claim 1, further comprising:
patterning the recording layer,
wherein the reinforcing layer is formed on the patterned recording layer.

4. The method of producing the patterned medium as claimed in claim 1, further comprising:
forming a non-magnetic layer on the cover layer; and
patterning the non-magnetic layer,
wherein the recording layer is formed on the patterned non-magnetic layer.

5. The method of producing the patterned medium as claimed in claim 1, wherein the main substrate is bonded on the reinforcing layer via a bonding layer.

6. The method of producing the patterned medium as claimed in claim 5, wherein the bonding layer is made of a material selected from a group consisting of an epoxy adhesive agent, a thermosetting resin, and an ultraviolet curing resin.

7. The method of producing the patterned medium as claimed in claim 1, further comprising:
planarizing the reinforcing layer,
wherein the main substrate is bonded on the planarized reinforcing layer.

8. The method of producing the patterned medium as claimed in claim 1, wherein the cover layer is made of Diamond-Like-Carbon (DLC).

9. The method of producing the patterned medium as claimed in claim 1, further comprising:
forming a mold releasing agent or wax between the provisional substrate and the cover layer.

10. The method of producing the patterned medium as claimed in claim 1, wherein said forming the recording layer forms a magnetic layer formed on the cover layer, and a soft magnetic layer formed on the magnetic layer.

11. The method of producing the patterned medium as claimed in claim 1, further comprising:
bonding, on another surface of the main substrate, a reinforcing layer of another recording part having a structure identical to that of the recording part, prior to removing the provisional substrate.

12. The method of producing the patterned medium as claimed in claim 11, wherein the reinforcing layer of the other recording part is bonded on the other surface of the main substrate via a bonding layer other than the bonding layer.

13. A patterned medium comprising:
a cover layer;
a patterned recording layer formed on the cover layer;
a reinforcing layer formed on the recording layer and forming a recording part together with the cover part and the recording layer; and
a main substrate,
wherein one surface of the main substrate is bonded to the reinforcing layer of the recording part via a bonding layer, and
an exposed surface of the cover layer is flat.

14. The patterned medium as claimed in claim 13, further comprising:
a non-magnetic layer disposed between the cover layer and the recording layer.

15. The patterned medium as claimed in claim 13, wherein the bonding layer is made of a material selected from a group consisting of an epoxy adhesive agent, a thermosetting resin, and an ultraviolet curing resin.

16. The patterned medium as claimed in claim 13, wherein the cover layer is made of Diamond-Like-Carbon (DLC).

17. The patterned medium as claimed in claim 13, wherein the recording layer includes a magnetic layer formed on the cover layer, and a soft magnetic layer formed on the magnetic layer.

18. The patterned medium as claimed in claim 13, further comprising:
another recording part having a structure identical to that of said recording part,
wherein a reinforcing layer of the other recording part is bonded to another surface of the main substrate.

19. The patterned medium as claimed in claim 18, further comprising:
another bonding layer other than said bonding layer,
wherein the reinforcing layer of the other recording part is bonded to the other surface of the main substrate via said other bonding layer.
